(19) United States
(12) Patent Application Publication
(10) Pub. No.: US 2022/0398966 A1
(43) Pub. Date: Dec. 15, 2022

(54) VEHICLE DISPLAY SYSTEM

(71) Applicant: TOYOTA JIDOSHA KABUSHIKI KAISHA, Aichi-ken (JP)

(72) Inventor: Kentaro OYA, Toyota-shi (JP)

(21) Appl. No.: 17/700,517

(22) Filed: Mar. 22, 2022

(30) Foreign Application Priority Data
Jun. 11, 2021 (JP) 2021-098284

(51) Int. Cl. G09G 3/20; G06V 20/59

(52) U.S. Cl. CPC G09G 3/2092; G06V 20/593; G09G 2380/10

(57) ABSTRACT

A vehicle display system includes: a display device that is mounted on an outer surface of a vehicle and that includes a display unit that notifies information to outside of the vehicle; and a controller that controls the display device. The controller receives a state inside the vehicle cabin from at least one of a device that changes the state inside the vehicle cabin of the vehicle and a device that detects the state inside the vehicle cabin, and performs control of displaying information indicating the state on the display unit of the display device.

### CROSS-REFERENCE TO RELATED APPLICATION

This application claims priority to Japanese Patent Application No. 2021-098284 filed on Jun. 11, 2021, incorporated herein by reference in its entirety.

### BACKGROUND

### 1. Technical Field

The present disclosure relates to a vehicle display system, and more particularly to a vehicle display system having a display device for notifying information to the outside of the vehicle.

### 2. Description of Related Art

Conventionally, a vehicle equipped with a device that generates a sterilizing action in order to sterilize a space inside a vehicle cabin and an object existing therein is known. Japanese Unexamined Patent Application Publication No. 2007-45174 (JP 2007-45174 A) discloses a vehicle equipped with an ion supply device that supplies positive ions having a sterilizing effect into the vehicle cabin.

In addition, an ultraviolet irradiation device for vehicles that sterilizes the interior of a vehicle cabin by irradiating it with ultraviolet rays has also appeared. The ultraviolet irradiation device irradiates UV-C that has a relatively short wavelength among ultraviolet rays, and the irradiation of UV-C kills bacteria in the air and on solid surfaces and inactivates the virus.

Ultraviolet rays (particularly UV-C) have bactericidal activity. However, when irradiated on the human body, ultraviolet rays are said to have a risk of causing eye damage, cancer due to DNA damage of the skin, and the like. Thus, in a vehicle equipped with an ultraviolet irradiation device that sterilizes by irradiating the inside the vehicle cabin with ultraviolet rays, it is necessary to suppress a person from getting into the vehicle cabin while the ultraviolet irradiation device is irradiating the inside the vehicle cabin with ultraviolet rays.

The state inside the vehicle cabin changes variously, including the state of whether the inside the vehicle cabin is being irradiated with ultraviolet rays. For example, the temperature and humidity inside the vehicle cabin change from moment to moment while the vehicle is running or parked. Further, in a vehicle such as a shared bus, the number of people inside the vehicle cabin changes variously while the vehicle is in operation.

### SUMMARY

A person outside the vehicle may not be able to grasp the state inside the vehicle cabin, and may realize that they have unintentionally boarded the vehicle or may realize that they should not have boarded the vehicle after boarding. Therefore, it is desired to be able to determine whether a person outside the vehicle should get into the vehicle.

A vehicle display system according to the present disclosure includes:

a display device that is mounted on an outer surface of a vehicle and that includes a display unit that notifies information to outside of the vehicle; and a controller that receives a state of an inside of a vehicle cabin of the vehicle from at least one of a device that changes the state inside the vehicle cabin and a device that detects the state inside the vehicle cabin, and that performs control of displaying information indicating the state on the display unit of the display device.

In the vehicle display system according to the present disclosure, the vehicle may include a door on a side portion, and the display unit of the display device may be mounted on an outer surface of the vehicle around the door.

In the vehicle display system according to the present disclosure, the device for changing the state inside the vehicle cabin may include an ultraviolet irradiation device that irradiates the inside the vehicle cabin with ultraviolet rays, and the controller may receive whether the inside the vehicle cabin is being irradiated with ultraviolet rays from the ultraviolet irradiation device as the state inside the vehicle cabin, and when the state is a state in which ultraviolet rays are being irradiated, the controller may perform control to display on the display unit of the display device that the room is being irradiated with ultraviolet rays.

In the vehicle display system according to the present disclosure, the controller may receive from the ultraviolet irradiation device, a completion rate that is a rate at which irradiation of the ultraviolet rays is completed and a remaining time until the irradiation of the ultraviolet rays is completed, and may perform control to display at least one of the completion rate and the remaining time on the display unit of the display device.

In the vehicle display system according to the present disclosure, the controller may receive a completion notification indicating that the irradiation of the ultraviolet rays is completed from the ultraviolet irradiation device, and may perform, when the controller receives the completion notification, control to display on the display unit of the display device that the irradiation of the ultraviolet rays inside the vehicle cabin is completed.

In the vehicle display system according to the present disclosure, the device for detecting the state inside the vehicle cabin may include a detection device that detects the number of people that are inside the vehicle cabin, and the controller may receive the number of people that are inside the vehicle cabin from the detection device as the state inside the vehicle cabin, and may perform control to display the number of people that are inside the vehicle cabin on the display unit of the display device.

In the vehicle display system according to the present disclosure, further included may be a memory that stores a capacity of the vehicle, and the controller may read the capacity of the vehicle from the memory, may calculate a boarding rate of the vehicle from the number of people that are inside the vehicle cabin and the capacity of the vehicle, and may perform control to display the boarding rate of the vehicle on the display unit of the display device.

In the vehicle display system according to the present disclosure, the device for detecting the state inside the vehicle cabin may include a detection device that detects the number of vacant seats that are inside the vehicle cabin, and the controller may receive the number of vacant seats that are inside the vehicle cabin from the detection device as the state inside the vehicle cabin, and perform control to display the number of vacant seats that are inside the vehicle cabin on the display unit of the display device.

In the vehicle display system according to the present disclosure, further included may be a memory that stores the number of seats that are inside the vehicle cabin, and the controller may read the number of seats that are inside the vehicle cabin from the memory, may calculate an vacant seat rate of the vehicle from the number of vacant seats that are inside the vehicle cabin and the number of seats that are inside the vehicle cabin, and may perform control to display the vacant seat rate of the vehicle on the display unit of the display device.

In the vehicle display system according to the present disclosure, the device for detecting the state inside the vehicle cabin may include a temperature sensor that detects the temperature inside the vehicle cabin, and the controller may receive the temperature inside the vehicle cabin from the temperature sensor as the state inside the vehicle cabin, and may perform control to display the temperature inside the vehicle cabin on the display unit of the display device.

In the vehicle display system according to the present disclosure, the device for detecting the state inside the vehicle cabin may include a humidity sensor that detects the humidity inside the vehicle cabin, and the controller may receive the humidity inside the vehicle cabin from the humidity sensor as the state inside the vehicle cabin, and may perform control to display the humidity inside the vehicle cabin on the display unit of the display device.

According to the present disclosure, since the display unit of the display device mounted on the outer surface of the vehicle allows a person outside the vehicle to grasp the state inside the vehicle cabin, it is possible to determine whether the person should get into the vehicle.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a perspective view of a vehicle according to an embodiment and shows a state in which ultraviolet rays are being irradiated inside the vehicle cabin;

FIG. 2 is a perspective view showing a state in which a vehicle door is open, and shows a state in which ultraviolet irradiation inside the vehicle cabin is completed;

FIG. 3 is a diagram showing the inside the vehicle cabin of the vehicle;

FIG. 4 is a functional block diagram of a vehicle display system;

FIG. 5 is a perspective view showing the vehicle in which an on-board battery is being charged;

FIG. 6 is a flowchart showing an example of control of a display device by a controller;

FIG. 7 is a perspective view showing the vehicle on which a boarding rate and the number of passengers are displayed on an outer surface;

FIG. 8 is a perspective view showing the vehicle in which a vacant seat rate and the number of vacant seats are displayed on the outer surface; and

FIG. 9 is a perspective view showing the vehicle in which the temperature inside the vehicle and the humidity inside the vehicle are displayed on the outer surface.

### DETAILED DESCRIPTION OF EMBODIMENTS

Hereinafter, an embodiment of the present disclosure will be described with reference to the drawings. The configuration described below is an example for explanation and can be appropriately changed according to the specifications of a vehicle and the like. In addition, it is initially possible to appropriately combine display contents of a display unit 20 of a display device 14 that will be described below, or to change them within a range that does not deviate from the gist of the present disclosure to obtain new display contents is assumed from the start. The same elements are designated by the same reference numerals in all drawings, and duplicate description is omitted.

In the following description, unless otherwise specified, the terms indicating the front-rear, right-left, and up-down, etc. directions indicate the directions related to a vehicle. In each figure, a direction of an arrow FR indicates a forward direction, a direction of an arrow UP indicates an upward direction, and a direction of an arrow RW indicates a rightward direction.

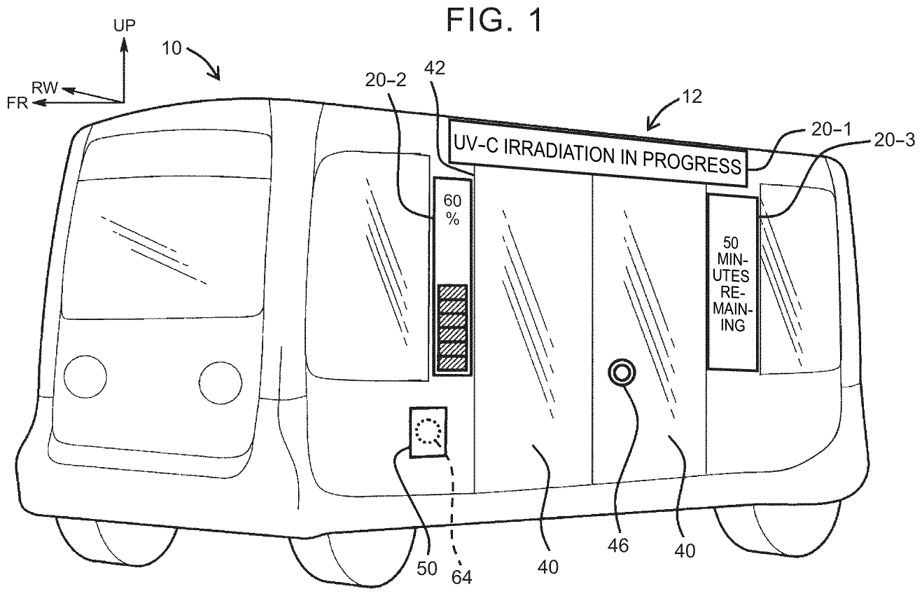

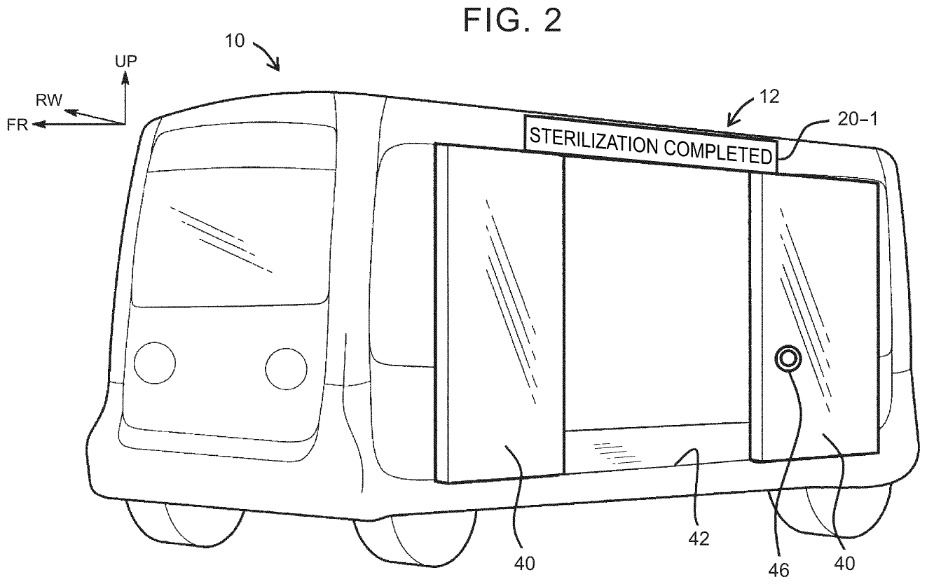

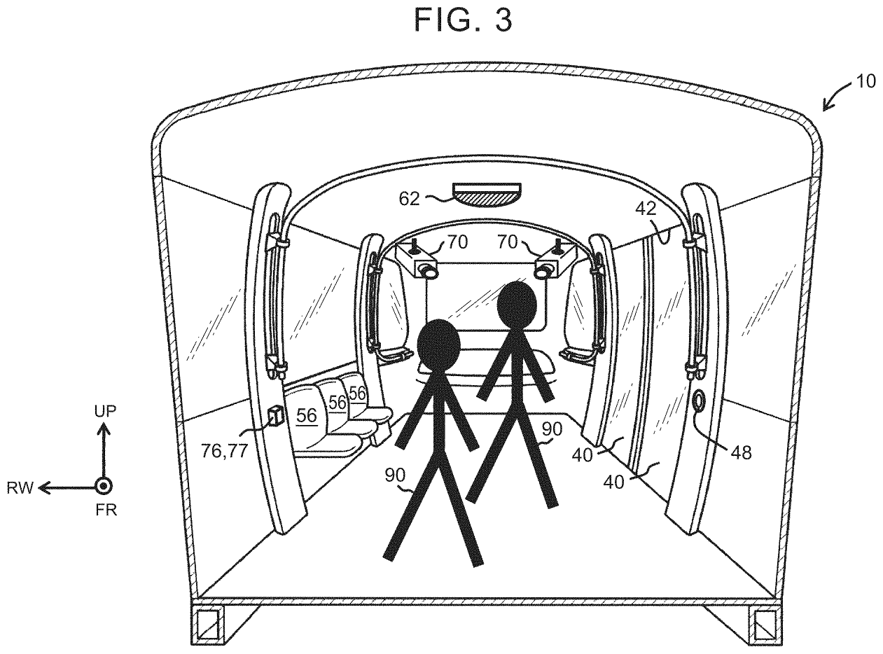

FIG. 1 is a perspective view of a vehicle 10 according to the embodiment. FIG. 2 is a perspective view showing a state in which doors 40 of the vehicle 10 are open. FIG. 3 is a diagram showing the inside of a vehicle cabin of the vehicle 10. FIG. 1 shows a state in which the inside the vehicle cabin is being sterilized by irradiating ultraviolet rays (UV-C) to the inside the vehicle cabin, and FIG. 2 shows a state in which the sterilization process is completed. It should be noted that FIG. 2 is a simplified drawing of the inside the vehicle cabin.

As shown in FIG. 1, the vehicle 10 has a substantially rectangular parallelepiped shape and is an automobile that can be autonomously driven. Specifically, the vehicle 10 can be operated in a plurality of operation modes including an autonomous operation mode and a manual operation mode. The vehicle 10 is a battery electric vehicle in which a drive source is a rotary electric machine (not shown). The vehicle 10 is equipped with a battery that supplies electric power to the rotary electric machine. As another embodiment, the vehicle 10 may be an automobile having an internal combustion engine as a drive source.

The vehicle 10 is used as a bus on which an unspecified number of passengers ride. However, a usage pattern of the vehicle 10 can be changed as appropriate. For example, the vehicle 10 may be used as a store such as a retail store that displays and sells various products, and a restaurant that cooks and provides food and drink. Further, the vehicle 10 may be used as an office for office work, meetings with customers, and the like. Further, the vehicle 10 may be used as a taxi for transporting a customer or luggage, a transportation vehicle, and the like. The usage scene of the vehicle 10 is not limited to business, and may be used, for example, as a means of transportation for an individual.

An entrance/exit 42 is provided on the vehicle body side portion of the vehicle 10. The entrance/exit 42 is located substantially in the center in a front-rear direction and is closed by the doors 40 when the vehicle is traveling. The doors 40 are sliding doors, and as shown in FIG. 2, the front side door 40 moves forward and the rear side door 40 moves rearward to open the entrance/exit 42.

The vehicle 10 includes a door button 46 arranged on the outer surface of the door 40, and a door button 48 arranged on the wall that is near the entrance/exit 42 and that is inside the vehicle cabin (see FIG. 3). In the closed state of the doors 40, the doors 40 are opened by pressing any one of the door buttons 46 and 48. Further, in the open state of the doors 40, the doors 40 are closed by pressing any one of the door buttons 46 and 48.

As shown in FIG. 1, display units 20-1, 20-2, 20-3 for notifying information to the outside of the vehicle 10 are mounted on the vehicle outer surface around the two doors 40. Each of the display units 20-1, 20-2, 20-3 is, for example, a liquid crystal display, an organic EL display, an LED display, or the like. The LED display is a display in which a large number of LED elements are arranged vertically and horizontally, and characters, symbols, and the like are expressed by selectively lighting the LED elements.

The display unit 20-1 has a horizontally elongated shape and is mounted on the upper side of the two doors 40. The display unit 20-2 has a vertically elongated shape and is mounted on the front side of the front side door 40. The display unit 20-3 has a vertically elongated shape and is mounted on the rear side of the rear side door 40. In the present embodiment, the vehicle is provided with three display units. However, the number of display units may be one, two, or four or more, and the mounting position of the display unit in the vehicle may be the vehicle front surface, the vehicle rear surface, and the like. As will be described in detail below, the display units 20-1, 20-2, 20-3 display the state inside the vehicle cabin, the progress information of the process performed inside the vehicle cabin, and the like.

As shown in FIG. 1, a lid 50 formed flush with the body is provided on the vehicle body side portion on the front side with respect to the entrance/exit 42. The upper end portion of the lid 50 is connected to the body via a hinge (not shown), and the lower end of the lid 50 is a free end. The lid 50 can be opened by rotating the lower end portion of the lid 50 to the vehicle outer side and upward around the hinge. The start button 64 for starting irradiation of ultraviolet rays from the main body (described later) of the ultraviolet irradiation device is arranged on the side portion of the vehicle body inside the lid 50. In each drawing other than FIG. 1, the lid 50 and the start button 64 are omitted.

As shown in FIG. 3, a main body 62 of the ultraviolet irradiation device is arranged on the ceiling of the vehicle 10. The main body 62 of the ultraviolet irradiation device irradiates the inside of the vehicle with ultraviolet rays (UV-C) to kill bacteria present in the space inside the vehicle cabin and the equipment arranged therein, or inactivates the virus. In this embodiment, only one main body 62 of the ultraviolet irradiation device is arranged. However, a plurality of main bodies 62 may be arranged. Further, the main body 62 of the ultraviolet irradiation device may be arranged on the wall inside the vehicle cabin, or the like.

As shown in FIG. 3, a plurality of passenger seats 56 are arranged in the vehicle cabin. In the figure, only a part of the seats 56 in the vehicle cabin is drawn, and the other seats 56 are omitted.

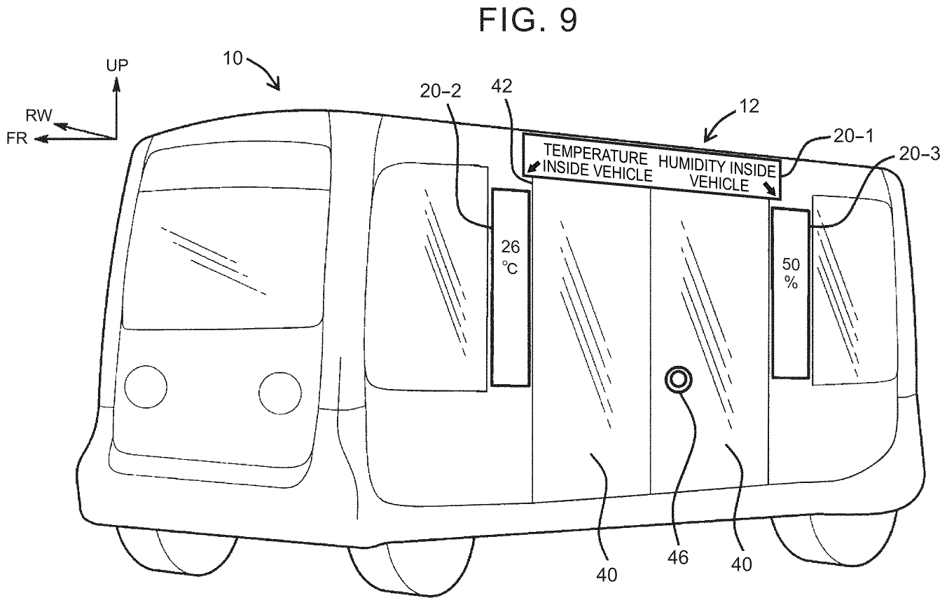

A temperature sensor 76 and a humidity sensor 77 are arranged on the wall inside the vehicle cabin, and in the present embodiment, the temperature sensor 76 and the humidity sensor 77 are integrated. The temperature sensor 76 is a detector that detects the temperature inside the vehicle cabin, and the humidity sensor 77 is a detector that detects the humidity inside the vehicle cabin. As shown in FIG. 9, the temperature of the inside of the vehicle cabin and the humidity of the inside of the vehicle cabin detected by these sensors are displayed on the display units 20-2, 20-3 of the display device.

As shown in FIG. 3, two cameras 70 are arranged on the ceiling at the rear portion inside the vehicle cabin, and although not shown, two cameras are also arranged on the ceiling at the front portion inside the vehicle cabin. That is, the cameras 70 are arranged at the four corners of the ceiling inside the vehicle cabin. Each of the cameras 70 is used to detect the number of people 90 inside the vehicle cabin and the number of vacant seats inside the vehicle cabin by photographing the inside the vehicle cabin. The number of cameras and the position of the cameras inside the vehicle cabin can be changed as appropriate.

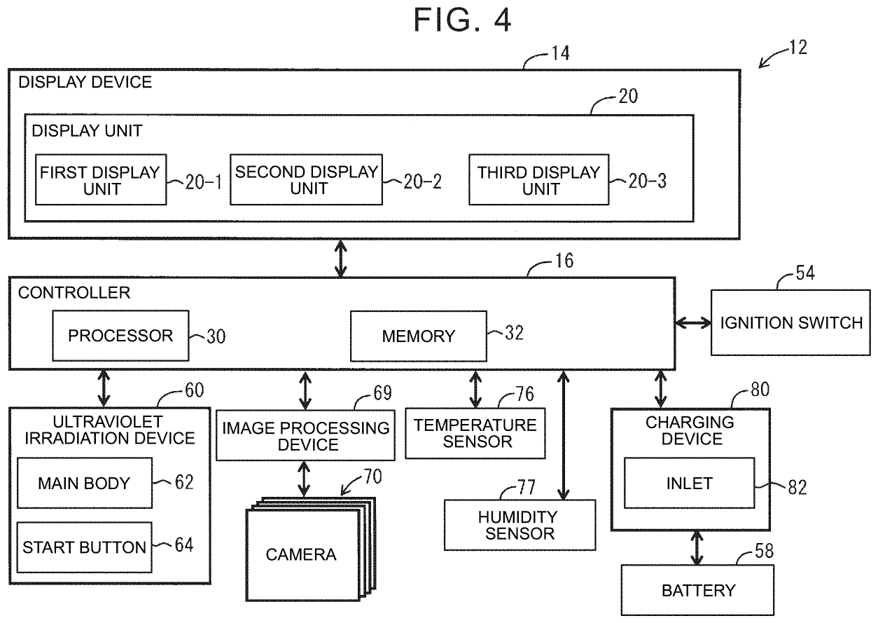

FIG. 4 is a functional block diagram of the display system 12 mounted on the vehicle. In the following, the above-mentioned display units 20-1, 20-2, and 20-3 will be referred to as the first display unit 20-1, the second display unit 20-2, and the third display unit 20-3, respectively, and will be collectively called the display unit 20. The display system 12 includes the display device 14 having the display unit 20 and a controller 16 for controlling the display device 14.

The controller 16 includes a processor 30 having a CPU and a memory 32 that stores a control program, control data, and the like. The memory 32 is, for example, a RAM, a ROM, a flash memory, or the like. The processor 30 controls the display device 14 by operating in accordance with the control program stored in the memory 32. The processor 30 may include an application specific integrated circuit (ASIC) or the like in place of or with the CPU.

The controller 16 receives the state inside the vehicle cabin from the device that changes the state inside the vehicle cabin of the vehicle 10 and the device that detects the state inside the vehicle cabin, and performs control of displaying the information indicating the state on the display unit 20 of the display device 14. In the present embodiment, the device that changes the state inside the vehicle cabin is the ultraviolet irradiation device 60, and the devices that detect the state inside the vehicle cabin is an image processing device 69, the cameras 70, the temperature sensor 76, and the humidity sensor 77. The image processing device 69 and the cameras 70 function as detection devices for detecting the number of people inside the vehicle cabin. They also function as detection devices that detect the number of vacant seats in the vehicle cabin.

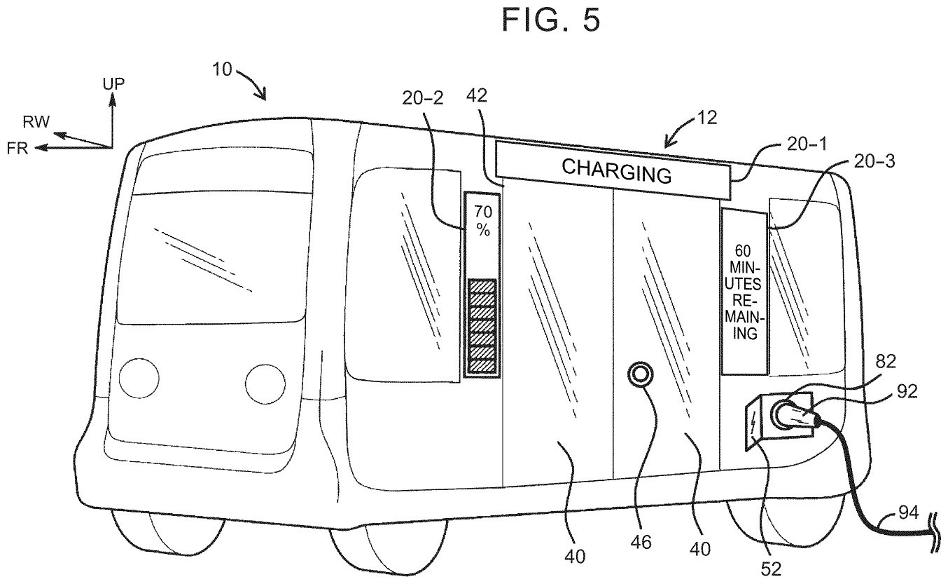

The vehicle 10 is equipped with the ultraviolet irradiation device 60. The ultraviolet irradiation device 60 includes the main body 62 arranged inside the vehicle cabin and the start button 64 arranged on the side portion of the vehicle body. When the lid 50 (see FIG. 1) on the side surface of the vehicle body is opened and the start button 64 is pressed by a crew member or the like, the ultraviolet rays (UV-C) are irradiated from the main body 62 of the ultraviolet irradiation device 60 and a process of sterilizing the inside the vehicle cabin is started. Then, when the set time stored in the on-board memory of the main body 62 of the ultraviolet irradiation device 60 elapses, the irradiation of the ultraviolet rays is autonomously terminated. Since the ultraviolet irradiation by the main body 62 of the ultraviolet irradiation device 60 requires a relatively large amount of electric power, the ultraviolet irradiation device 60 may be configured to only operate when an inlet 82 (see FIG. 5) of a vehicle charging device 80 is connected to a connector 92 (charging connector) of a charging cable 94 and electric power is supplied to the vehicle 10 from the outside.

Further, the vehicle 10 is equipped with a battery 58 that supplies electric power to a rotary electric machine (vehicle drive source) and the charging device 80 that charges the battery 58. The charging device 80 includes the inlet 82 to which the connector of the charging cable is connected. FIG. 5 shows a part of the inlet 82 of the charging device 80. As shown in FIG. 5, the inlet 82 is arranged, for example, on the side portion of the vehicle body, is normally covered with the lid 52, and the lid 52 is opened as shown in the figure when charging the battery so that the connector 92 of the charging cable 94 is connected. The end portion on the opposite side of the charging cable 94 from the connector 92 is connected to a power source (not shown), and the vehicle battery 58 can be charged by connecting the connector 92 to the vehicle inlet 82.

Further, the vehicle 10 is equipped with the image processing device 69 electrically connected to the cameras 70 arranged inside the vehicle cabin. The image processing device 69 has a function of acquiring an image of the inside the vehicle cabin from the cameras 70 and analyzing the image of each camera 70 by existing technology (for example, pattern matching or the like) to detect a person inside the vehicle cabin. The image processing device 69 detects a person inside the vehicle cabin and then counts the detected person to acquire the number of people 90 inside the vehicle cabin. Further, the image processing device 69 also has a function of detecting an vacant seat (the seat 56 in which an occupant is not sitting) inside the vehicle cabin by analyzing an image of each of the cameras 70 by an existing technique (for example, pattern matching or the like). The image processing device 69 acquires the number of vacant seats inside the vehicle cabin by counting the detected vacant seats after detecting the vacant seats inside the vehicle cabin.

As shown in FIG. 4, in the controller 16, the display device 14, the ultraviolet irradiation device 60, the image processing device 69, the temperature sensor 76, the humidity sensor 77, the charging device 80, and a vehicle ignition switch 54 are electrically connected.

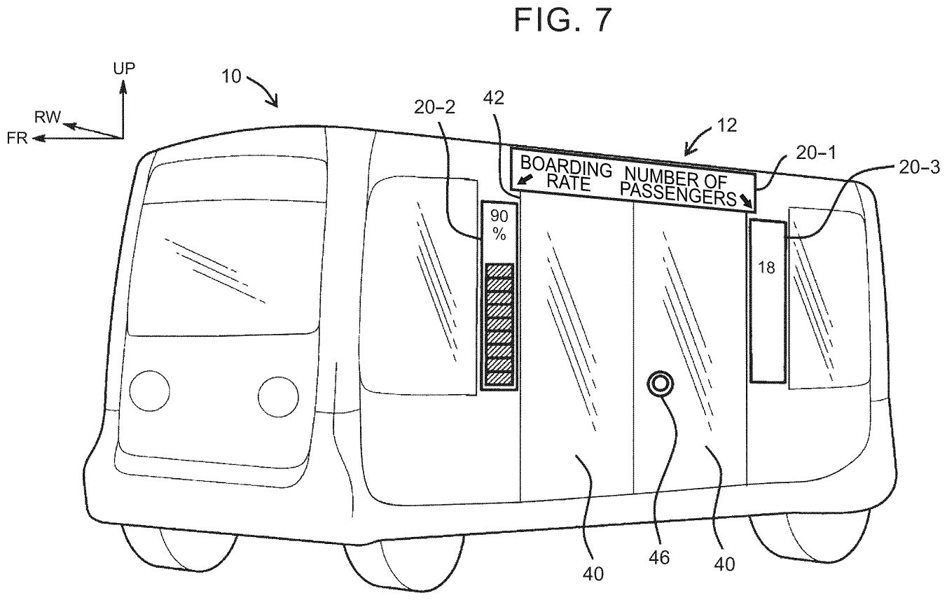

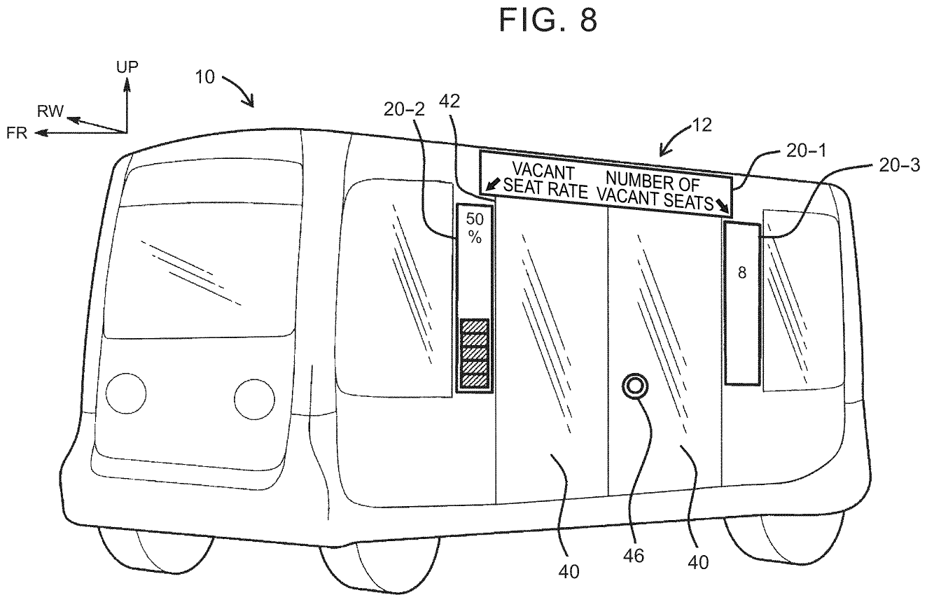

Next, the operation of the display system 12 will be described. The controller 16 uses the display unit 20 of the display device 14 to perform display regarding the ultraviolet irradiation (FIGS. 1 and 2), display of the boarding rate and the number of passengers (FIG. 7), display of the vacant seat rate and the number of vacant seats (FIG. 8), display of the temperature inside the vehicle and the humidity inside the vehicle (FIG. 9), and display regarding the battery charge (FIG. 5). Among these displays, five displays (FIGS. 1, 2, 7 to 9) excluding the display regarding battery charge (FIG. 5) are displays indicating the state inside the vehicle cabin. Hereinafter, these displays will be described. For example, when the display space of the display unit 20 of the display device 14 is large, all or part of these displays can be performed at the same time.

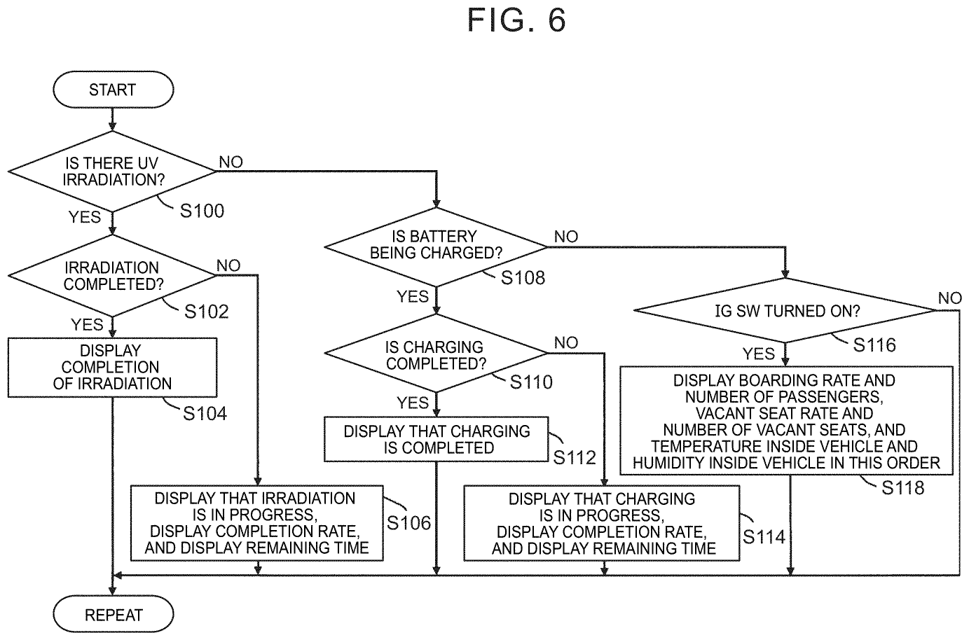

FIG. 6 is a flowchart showing an example of control of the display device 14 by the controller 16. The flow of FIG. 6 is repeatedly executed at a predetermined cycle. In S100, the controller 16 receives from the ultraviolet irradiation device 60, whether the inside the vehicle cabin is being irradiated with ultraviolet rays. Then, when the state is a state in which irradiation of ultraviolet rays is in progress (S100: YES), the controller 16 proceeds to S102 and thereafter and performs display regarding the ultraviolet irradiation (FIGS. 1 and 2).

Display Regarding UV Irradiation

In S102, the controller 16 confirms whether the completion notification indicating that the ultraviolet irradiation has been completed has been received from the ultraviolet irradiation device 60. Since the controller 16 has not received the completion notification at this point (S102: NO), the controller 16 proceeds to S106.

In S106, the controller 16 performs control to display on the first display unit 20-1 of the display device 14 that the inside the vehicle cabin is being irradiated with ultraviolet rays. FIG. 1 shows a display example of the first display unit 20-1 in this case. In this embodiment, the first display unit 20-1 displays “UV-C irradiation in progress”.

Further, the controller 16 receives from the ultraviolet irradiation device 60, the completion rate that is the rate at which the irradiation of the ultraviolet rays is completed and the remaining time until the irradiation of the ultraviolet rays is completed. Then, the controller 16 performs control to display the received completion rate on the second display unit 20-2 of the display device 14, and performs control to display of the received remaining time received on the third display unit 20-3 of the display device 14. FIG. 1 shows a display example of the second display unit 20-2 and the third display unit 20-3 in this case. In this embodiment, as shown in FIG. 1, the controller 16 also performs control of displaying a corresponding gauge in the second display unit 20-2 in addition to the completion rate (60% in the example of the figure). The gauge represents the completion rate in the form of a columnar graph (in this embodiment, it is represented by stacking filled square frames). Various types of gauges can be adopted as long as the magnitude of the numerical value can be visually grasped. This also applies to the gauges of FIGS. 5, 7, and 8 described below. Then, the controller 16 ends the process of this cycle.

According to the display related to such ultraviolet irradiation (FIG. 1), the first display unit 20-1 allows a person outside the vehicle to know that the inside of the vehicle cabin is irradiated with ultraviolet rays (UV-C). Thus, it is possible to suppress the person from accidentally getting into the vehicle being irradiated with ultraviolet rays. Further, the second display unit 20-2 displays the rate at which the ultraviolet irradiation is completed (completion rate), and the third display unit 20-3 displays the remaining time until the ultraviolet irradiation is completed. Thus, the person outside the vehicle can keep track of the progress of UV irradiation. In this embodiment, both the completion rate and the remaining time are displayed. However, only one of them may be displayed.

The controller 16 receives the completion notification of the ultraviolet irradiation from the ultraviolet irradiation device 60 while repeatedly executing S100, S102, and S106. When the controller 16 receives the completion notification from the ultraviolet irradiation device 60 (S102: YES), the controller 16 proceeds to S104. In S104, the controller 16 performs control to display on the first display unit 20-1 of the display device 14 that the irradiation of the ultraviolet rays inside the vehicle cabin is completed. FIG. 2 shows a display example of the first display unit 20-1 in this case. In this embodiment, the first display unit 20-1 displays “sterilization completed”. As a result, it is possible for the person outside the vehicle to know that the irradiation of ultraviolet rays is completed and that the person can get inside the vehicle. It should be noted that the display of irradiation completion (sterilization completion) may be performed for a predetermined time, and then the display may be turned off.

When S100 is NO, the controller 16 proceeds to S108. In S108, the controller 16 receives from the charging device 80 whether the battery 58 is being charged. Then, when the state is charging the battery 58 (S108: YES), the controller 16 proceeds to S110 and thereafter, and displays the battery charging (FIG. 5).

Display Regarding Battery Charging

In S110, the controller 16 confirms whether the charging device 80 has received the completion notification indicating that the charging of the battery 58 is completed. Since the controller 16 has not received the completion notification at this point (S110: NO), the controller 16 proceeds to S114.

In S114, the controller 16 performs control to display on the first display unit 20-1 of the display device 14 that the battery 58 is being charged. FIG. 5 shows a display example of the first display unit 20-1 in this case. In this embodiment, the first display unit 20-1 displays “charging in progress”.

Further, the controller 16 receives from the charging device 80, the completion rate that is the rate at which the charging of the battery 58 is completed, and the remaining time until the charging of the battery 58 is completed. Then, the controller 16 performs control to display the received completion rate on the second display unit 20-2 of the display device 14, and performs control to display of the received remaining time received on the third display unit 20-3 of the display device 14. FIG. 5 shows a display example of the second display unit 20-2 and the third display unit 20-3 in this case. In this embodiment, as shown in FIG. 5, the controller 16 also performs control of displaying the gauge corresponding to the completion rate (70% in the example of the figure) on the second display unit 20-2 to display, in addition to the completion rate. Then, the controller 16 ends the process of this cycle.

According to the display related to such battery charging (FIG. 5), due to the first display unit 20-1, a person outside the vehicle can easily grasp that the battery 58 is being charged. Further, the second display unit 20-2 displays the rate at which the battery 58 has been fully charged, and the third display unit 20-3 displays the remaining time until the battery 58 is fully charged. Thus, a person outside of the vehicle can keep track of the progress of the charging of the battery. In this embodiment, both the battery charge completion rate and the remaining time are displayed. However, only one of them may be displayed.

The controller 16 receives a battery charge completion notification from the charging device 80 while repeatedly executing S108, S110, and S114. When the controller 16 receives the completion notification from the charging device 80 (S110: YES), the controller 16 proceeds to S112. In S112, the controller 16 performs control to display on the first display unit 20-1 of the display device 14 that the charging of the battery 58 is completed. Although this display is not shown, for example, the first display unit 20-1 displays “charge completed”. As a result, a person outside the vehicle can know that the charging of the battery 58 is completed. It should be noted that the display of charging completion may be performed for a predetermined time, and then the display may be turned off.

When S108 is NO, the controller 16 proceeds to S116. In S116, the controller 16 confirms whether the ignition switch 54 of the vehicle 10 is in the on state. When the ignition switch 54 is not in the on state (off state, S116: NO), the controller 16 ends the process of this cycle. On the other hand, the controller 16 proceeds to S118 when the ignition switch 54 is in the ON state (S116: YES).

In S118, the controller 16 displays the boarding rate and the number of passengers (FIG. 7), the vacant seat rate and the number of vacant seats (FIG. 8), and the temperature inside the vehicle and the humidity inside the vehicle (FIG. 9) on the display unit 20 of the display device 14 in order at predetermined time intervals. That is, so as to display the boarding rate and the number of passengers for only a predetermined time (FIG. 7), then display the vacant seat rate and the number of vacant seats for the same amount of time (FIG. 8), then display the temperature inside the vehicle and the humidity inside the vehicle for the same amount of time (FIG. 9), and then display the boarding rate and the number of passengers again (FIG. 7), the controller 16 performs control of repeating display of the above, while repeatedly executing S118 in the flow of FIG. 6. Hereinafter, each of these displays will be described.

Display of Boarding Rate and Number of Passengers

First, the display of the boarding rate and the number of passengers will be described. The controller 16 receives the number of people (number of passengers) inside the vehicle cabin from the image processing device 69. Then, the controller 16 performs control to display the received number of people inside the vehicle cabin on the third display unit 20-3 of the display device 14. FIG. 7 shows a display example of the third display unit 20-3 in this case.

Further, the memory 32 of the controller 16 stores the capacity of the vehicle 10. The capacity of the vehicle 10 may be stored in a memory outside the controller 16. The controller 16 reads the capacity of the vehicle from the memory and divides the number of people inside the vehicle cabin received from the image processing device 69 by the capacity of the vehicle to calculate the boarding rate of the vehicle. Then, the controller 16 performs control to display the calculated boarding rate of the vehicle on the second display unit 20-2 of the display device 14. FIG. 7 shows a display example of the second display unit 20-2 in this case. As shown in FIG. 7, the controller 16 also performs control of displaying a gauge corresponding to the boarding rate (90% in the example of the figure) on the second display unit 20-2, in addition to displaying the boarding rate.

Further, the controller 16 performs control to display a sign on the first display unit 20-1 of the display device 14 to indicate that the second display unit 20-2 and the third display unit 20-3 represent the “boarding rate” and the “number of passengers” (see FIG. 7).

With such a display of the boarding rate and the number of passengers (FIG. 7), a person outside the vehicle can easily recognize the number of passengers in the vehicle. For example, when the vehicle 10 stops at a bus stop, a person waiting at the bus stop can determine whether to board the vehicle by checking the boarding rate and the number of passengers of the vehicle displayed around the door 40 of the vehicle 10. For example, when the boarding rate is high, it is possible to avoid getting onto the vehicle, and when the boarding rate is low, it is possible to actively get into the vehicle. In this embodiment, both the boarding rate and the number of passengers are displayed. However, only one of them may be displayed.

Display of Vacant Seat Rate and Number of Vacant Seats

Next, the display of the vacant seat rate and the number of vacant seats will be described. The controller 16 receives the number of vacant seats inside the vehicle cabin from the image processing device 69. Then, the controller 16 performs control to display the number of vacant seats inside the vehicle cabin on the third display unit 20-3 of the display device 14. FIG. 8 shows a display example of the third display unit 20-3 in this case.

Further, the memory 32 of the controller 16 stores the number of seats 56 inside the vehicle cabin. The number of seats 56 inside the vehicle cabin may be stored in a memory outside the controller 16. The controller 16 reads the number of seats 56 inside the vehicle cabin from the memory and divides the number of vacant seats inside the vehicle cabin received from the image processing device 69 by the number of seats 56 inside the vehicle cabin to calculate the vacant seat rate of the vehicle. Then, the controller 16 performs control to display the calculated vacant seat rate of the vehicle on the second display unit 20-2 of the display device 14. FIG. 8 shows a display example of the second display unit 20-2 in this case. As shown in FIG. 8, the controller 16 also controls the second display unit 20-2 to display the gauge corresponding to the vacant seat rate in addition to the vacant seat rate (50% in the example in FIG. 8).

Further, the controller 16 performs control to display a sign on the first display unit 20-1 of the display device 14 to indicate that the second display unit 20-2 and the third display unit 20-3 represent the “vacant seat rate” and the “vacant seat number”, respectively (see FIG. 8).

According to the display of the vacant seat rate and the number of vacant seats (FIG. 8), a person outside the vehicle can grasp the vacant seat status inside the vehicle cabin. For example, when the vehicle 10 stops at a bus stop, a person waiting at the bus stop can determine whether to board the vehicle by checking the vacant seat rate and the number of passengers of the vehicle displayed around the door 40 of the vehicle 10. For example, when the vacant seat rate is low or 0%, it is possible to avoid getting into the vehicle, and when the vacant seat rate is high or not 0%, it is possible to actively get into the vehicle. In this embodiment, both the vacant seat rate and the number of vacant seats are displayed. However, only one of them may be displayed.

Display of Temperature Inside the Vehicle and Humidity Inside the Vehicle

Next, the display of the temperature inside the vehicle and the humidity inside the vehicle will be described. The controller 16 receives the temperature inside the vehicle cabin (vehicle cabin temperature) from the temperature sensor 76 arranged inside the vehicle cabin, and performs control to display it on the second display unit 20-2 of the display device 14. FIG. 9 shows a display example of the second display unit 20-2 in this case. Further, the controller 16 receives the humidity inside the vehicle cabin (humidity in the vehicle) from the humidity sensor 77 arranged inside the vehicle cabin, and performs control to display it on the third display unit 20-3 of the display device 14. FIG. 9 shows a display example of the third display unit 20-3 in this case. Further, the controller 16 performs control to display a sign on first display unit 20-1 of the display device 14 to indicate that the second display unit 20-2 and the third display unit 20-3 represent the “temperature in the vehicle” and the “humidity in the vehicle”, respectively (see FIG. 9).

According to the display of the temperature inside the vehicle and the humidity inside the vehicle (FIG. 9), a person outside the vehicle can recognize the state of the air environment inside the vehicle cabin. For example, a person outside the vehicle 10 can determine whether to board the vehicle 10 by checking the temperature inside the vehicle and the humidity inside the vehicle displayed around the door 40 of the vehicle 10.

Although the flow of FIG. 6 has been described above, the timing of each display and the form of each display can be changed as appropriate. For example, the controller 16 may perform control to display on the display unit 20 of the display device 14, simultaneously all or part of the boarding rate and the number of passengers (FIG. 7), the vacant seat rate and the number of vacant seats (FIG. 8), and the temperature inside the vehicle and the humidity inside the vehicle (FIG. 9). Further, for example, during the ultraviolet irradiation of the ultraviolet irradiation device 60 or the battery charging of the charging device 80, the controller 16 may perform control of displaying on the display unit 20 of the display device 14, an animation display (for example, a display in which a person, an object, an animal, and the like seem to be moving) indicating that the process of irradiation or charging is being performed.

The vehicle 10 of the embodiment described above is a fixed-route bus. However, the vehicle 10 is not limited thereto. The vehicle 10 may be, for example, a passenger car used by an individual or the like.

What is claimed is:

1. A vehicle display system comprising:
a display device that is mounted on an outer surface of a vehicle and that includes a display unit that notifies information to outside of the vehicle; and
a controller that receives a state inside a vehicle cabin of the vehicle from at least one of a device that changes the state inside the vehicle cabin and a device that detects the state inside the vehicle cabin, and that performs control of displaying information indicating the state on the display unit of the display device.

2. The vehicle display system according to claim 1,
wherein the vehicle includes a door on a side portion, and
wherein the display unit of the display device is mounted on an outer surface of the vehicle around the door.

3. The vehicle display system according to claim 1,
wherein the device for changing the state inside the vehicle cabin includes an ultraviolet irradiation device that irradiates an inside of the vehicle cabin with ultraviolet rays; and
wherein the controller receives whether the inside of the vehicle cabin is being irradiated with the ultraviolet rays from the ultraviolet irradiation device as the state inside the vehicle cabin, and when the state is a state in which the inside of the vehicle cabin is being irradiated with the ultraviolet rays, the controller performs control to display on the display unit of the display device that the inside of the vehicle cabin is being irradiated with the ultraviolet rays.

4. The vehicle display system according to claim 3, wherein the controller
receives from the ultraviolet irradiation device, a completion rate that is a rate at which irradiation of the ultraviolet rays is completed and a remaining time until the irradiation of the ultraviolet rays is completed, and
performs control to display at least one of the completion rate and the remaining time on the display unit of the display device.

5. The vehicle display system according to claim 3, wherein the controller
receives from the ultraviolet irradiation device, a completion notification indicating that the irradiation of the ultraviolet rays is completed, and
performs, when the controller receives the completion notification, control to display on the display unit of the display device that the irradiation of the inside of the vehicle cabin with the ultraviolet rays is completed.

6. The vehicle display system according to claim 1,
wherein the device for detecting the state inside the vehicle cabin includes a detection device that detects the number of people that are inside the vehicle cabin, and
wherein the controller
receives the number of people that are inside the vehicle cabin from the detection device as the state inside the vehicle cabin, and
performs control to display the number of people that are inside the vehicle cabin on the display unit of the display device.

7. The vehicle display system according to claim 6, further comprising a memory that stores a capacity of the vehicle, and
wherein the controller
reads the capacity of the vehicle from the memory,
calculates a boarding rate of the vehicle from the number of people that are inside the vehicle cabin and the capacity of the vehicle, and
performs control to display the boarding rate of the vehicle on the display unit of the display device.

8. The vehicle display system according to claim 1,
wherein the device for detecting the state inside the vehicle cabin includes a detection device that detects the number of vacant seats that are inside the vehicle cabin, and
wherein the controller
receives the number of vacant seats that are inside the vehicle cabin from the detection device as the state inside the vehicle cabin, and
performs control to display the number of vacant seats that are inside the vehicle cabin on the display unit of the display device.

9. The vehicle display system according to claim 8, further comprising a memory that stores the number of seats that are inside the vehicle cabin, and
wherein the controller
reads the number of seats that are inside the vehicle cabin from the memory,
calculates a vacant seat rate of the vehicle from the number of vacant seats that are inside the vehicle cabin and the number of seats that are inside the vehicle cabin, and
performs control to display the vacant seat rate of the vehicle on the display unit of the display device.

10. The vehicle display system according to claim 1,
wherein the device for detecting the state inside the vehicle cabin includes a temperature sensor that detects a temperature inside the vehicle cabin, and
wherein the controller
receives the temperature inside the vehicle cabin from the temperature sensor as the state inside the vehicle cabin, and
performs control to display the temperature inside the vehicle cabin on the display unit of the display device.

11. The vehicle display system according to claim 1,
wherein the device for detecting the state inside the vehicle cabin includes a humidity sensor that detects a humidity inside the vehicle cabin, and
wherein the controller
receives the humidity inside the vehicle cabin from the humidity sensor as the state inside the vehicle cabin, and
performs control to display the humidity inside the vehicle cabin on the display unit of the display device.
